(19) United States
(12) Patent Application Publication
(10) Pub. No.: US 2010/0051732 A1
(43) Pub. Date: Mar. 4, 2010

(54) Connector and high frequency vibration device having the same

(75) Inventor: Wen-Chi Li, Taipei City (TW)

Correspondence Address: EDWARDS ANGELL PALMER & DODGE LLP, P.O. BOX 55874, BOSTON, MA, 02205, US

(73) Assignee: Exland Biotech Inc., Taipei City (TW)

(21) Appl. No.: 12/231,629

(22) Filed: Sep. 3, 2008

(51) Int. Cl. B02C 23/00

(52) U.S. Cl. 241/283

(57) ABSTRACT

A connector is provided, which is applicable to a high frequency vibration generator of a high frequency disintegrator. The high frequency. vibration generator has an axially installed operational portion for outputting high frequency vibration energy. The connector includes a connecting portion axially connected to the high frequency vibration generator, an action portion axially extended from an end of the connecting portion, and an inlet and an outlet, which communicate with the action portion and are located on different planes from each other. A high frequency vibration device having the connector is also provided.

### BACKGROUND OF THE INVENTION

1. Field of the Invention

The present invention relates to material disintegration techniques, and more particularly, to a connector applicable to a high frequency vibration generator, and a high frequency vibration device having the connector.

2. Description of Related Art

Ultrasonic technology is well known in the art for the following applications: medical ultrasonography, ultrasonic motion drive, ultrasonic probing, ultrasonic signal detection, and ultrasound for industrial processing. Technically, ultrasounds are sounds that cannot be heard by the human ear, and they generate a physical vibration that is transmitted through a medium. For ultrasound in a fluid, cavitation is created in the fluid by highly intensive ultrasonic waves. Such cavitation generates small vacuum bubbles having a diameter of approximately one-ten-thousandth centimeter, and these small vacuum bubbles, when being broken, are able to locally generate a pressure of 1,000 atm, which in turn creates a strong impact to wash away dirt or hit cell walls of cells in materials, thereby releasing contents (or lysate) of cells when the cell walls are broken.

For use in material disintegration, ultrasound must be transmitted by a medium. Referring to FIG. 1, a conventional ultrasonic disintegrator I is illustrated. The ultrasonic disintegrator 1 includes an ultrasonic device 11, a vibration head 12 connected to the ultrasonic device 11, a containing device 13, and a stirring device 14. The ultrasonic device 11 is installed at the center of the containing device 13. The vibration head 12 has a piezoelectric material (e.g. piezoelectric blade) therein through which a piezoelectric effect is generated, thereby creating high frequency vibration. Besides, the containing device 13 contains a medium and a material (such as a solid) therein. The medium can be a fluid medium for transferring high frequency vibration energy, for example, a fluid based on a liquid (such as water). The stirring device 14 is installed inside the containing device 13, for continuously stirring the medium and the material.

Through the use of the ultrasonic disintegrator 1, during material disintegration in practice, vibration of the vibration head 12 transfers the high frequency vibration energy to the containing device 13, allowing a plurality of small vacuum bubbles to be generated by cavitation in the medium surrounding the vibration head 12. And, an impact created when the small vacuum bubbles are broken is used to disintegrate the material, thereby accomplishing the result of material disintegration.

However, by the aforementioned conventional technique, as the ultrasonic device 11 and the vibration head 12 are located at the center of the containing device 13, the vibration head 22 transfers the high frequency vibration energy downward, and thus the generated high frequency vibration energy tends to be easily concentrated at the center and gradually decreased toward the periphery of the containing device 13. As such, the material situated at the periphery of the containing device 13 cannot be effectively disintegrated as expected due to insufficient vibration energy, thereby leading to uneven disintegration.

Further, due to such unevenness, the medium and the material must be repeatedly stirred. Even so, it is difficult to confirm whether the desired evenness is reached or not, while the amount of disintegrated material obtained is limited even after a long period of time of operation. Hence, the above conventional technique is only applicable for laboratory-scale use but not for large-scale use.

Moreover, the containing device 13 of the conventional ultrasonic disintegrator 1 is nearly sealed. When the high frequency vibration energy continues to disintegrate material in the containing device 13, a large amount of heat is generated, thereby increasing the temperature of the medium. When this happens, the disintegration process must be terminated and an additional temperature-cooling step should be performed to prevent the medium from being overheated, so as not to affect stability and integrity of the properties of the disintegrated material. In particular, when disintegrating a material such as Chinese herbal medicine, natural organic product, etc, a high temperature usually destroys the structure of the cell contents or lysate of the material to be extracted.

In other words, even if the aforementioned conventional technique may disintegrate the material into powder particles, it is not able to carry out an extraction process. And, the amount of material that can be disintegrated one time is limited, such that the conventional technique is not suitable for large-scale use.

As shown in FIG. 2, the Taiwanese Patent Application No. 093119250 discloses another conventional ultrasonic disintegrator 2. The ultrasonic disintegrator 2 includes an ultrasonic device 21, a vibration head 22 connected to the ultrasonic device 21, and a suspension carrier device 23 connected to the vibration head 22. The vibration head 22 has a piezoelectric material. The suspension carrier device 23 includes a transmission tube 231 connected to the vibration head 22, a transmission pump 232 connected to the transmission tube 231, and a cooler 233 connected to the transmission tube 231, thereby using the transmission pump 232 to control the flow speed, and allowing the material and the medium to flow in the transmission tube 231, for disintegration.

However, the transmission tube 231 of the suspension carrier device 23 of the conventional ultrasonic disintegrator 2 is radially installed under the ultrasonic device 21 and the vibration head 22. Hence, the vibration head 22 only acts on the material located within a radial height of the transmission tube 231, and the radial height is just about an inner diameter of the transmission tube 231, such that the action distance is extremely short. As the time by which the vibration head 22 acts on the material is relatively short, uneven disintegration easily occurs. And, when the disintegrated material particles are different in size due to different disintegration degrees, a later extraction process would be adversely affected, thereby degrading the extraction progress and the extraction yield.

Furthermore, in order to be connected to the vibration head, the transmission tube 231 of this ultrasonic disintegrator 2 must have a size greater than that of the vibration head 22, and accordingly, the vibration head 22 has relatively less action unit area and shorter action time. In order to achieve evenness, the material must be continuously circulated. However, as the vibration head 22 transfers the high frequency vibration energy downward, if the material circulated by such an ultrasonic disintegrator 2 is located on the sidewall of the transmission tube 231, it may not receive sufficient vibration energy and then the expected disintegrating effect cannot be achieved. Even if the material is located right at the center of the transmission tube 231, effective disintegration cannot be achieved as well due to short-time operation applied to the material being continuously circulated. As a result, even if the material is continuously circulated, it cannot ensure that effective disintegration of all the material is accomplished.

In addition, the aforementioned two conventional ultrasonic disintegrators are each a single and independent apparatus. When massive amount of material disintegration is required, a considerable number of associated devices/equipment must be simultaneously utilized. Hence, if the conventional techniques are applied in large-scale use, the manufacturing cost is certainly increased.

Therefore, the problem to be solved here is to develop a material disintegration technique, which can overcome the drawbacks of the above conventional techniques.

### SUMMARY OF THE INVENTION

In view of the above disadvantages of the conventional technique, an objective of the present invention is to provide a connector and a high frequency vibration device having the same, so as to achieve even material disintegration.

Another objective of the present invention is to provide a connector and a high frequency vibration device the same, so as to increase efficiency thereof.

Still another objective of the present invention is to provide a connector and a high frequency vibration device the same, suitable for large-scale use.

A further objective of the present invention is to provide a connector and a high frequency vibration device having the same, which are cost-effective.

To achieve the aforementioned and other objectives, the present invention provides a connector and a high frequency vibration device having the same, wherein the connector is applicable to a high frequency vibration generator, for allowing the high frequency vibration generator to output high frequency vibration energy.

The connector includes a connecting portion, an action portion, and an inlet and an outlet. The connecting portion is connected to the high frequency vibration generator. The action portion is axially extended from an end of the connecting portion, for allowing the high frequency vibration generator to output the high frequency vibration energy axially. The inlet and the outlet communicate with the action portion and are located on different axial planes from each other.

The high frequency vibration generator has an operational portion that outputs the high frequency vibration energy axially, wherein the operational portion is axially connected to the connecting portion. The action portion is, for example, an axially extended action channel. The operational portion outputs ultrasonic vibration energy axially in the action portion. In an embodiment, the connector further comprises an extension portion integrally extended from an end of the action portion opposite to the operational portion, thereby increasing the length of the action channel and the action time by which the high frequency vibration energy affects a material so as to more evenly disintegrate the material. In other embodiments, the axial length of the action portion may be directly increased so as to extend the path (length) and time in which the high frequency vibration energy acts on the material.

Moreover, the aforementioned high frequency vibration device can be formed by one connector and one high frequency vibration generator. Alternatively, the high frequency vibration device may comprise a plurality of connectors connected in series with a plurality of high frequency vibration generators, thereby allowing the connectors to be connected in series to each other.

In comparison to the conventional techniques, the connector of the present invention has a relatively longer action portion, thereby relatively extending the time that the operational portion of the high frequency vibration generator acts on the material, such that the problem of uneven material disintegration in the conventional techniques can be solved, while the efficiency can be enhanced in the present invention. Moreover, the connectors may be connected in series to each other, making the high frequency vibration device suitable for large-scale use, thereby effectively solving the problem of the conventional techniques not applicable for large-scale use. In addition, the yield can be increased by the series-connection arrangement in the present invention, such that the present invention provides a cost-effective way to lower to the manufacturing cost, as compared to the conventional techniques where a considerable number of associated devices/equipment are required.

### BRIEF DESCRIPTION OF DRAWINGS

FIG. 1 is a schematic diagram of a conventional ultrasonic disintegrator;

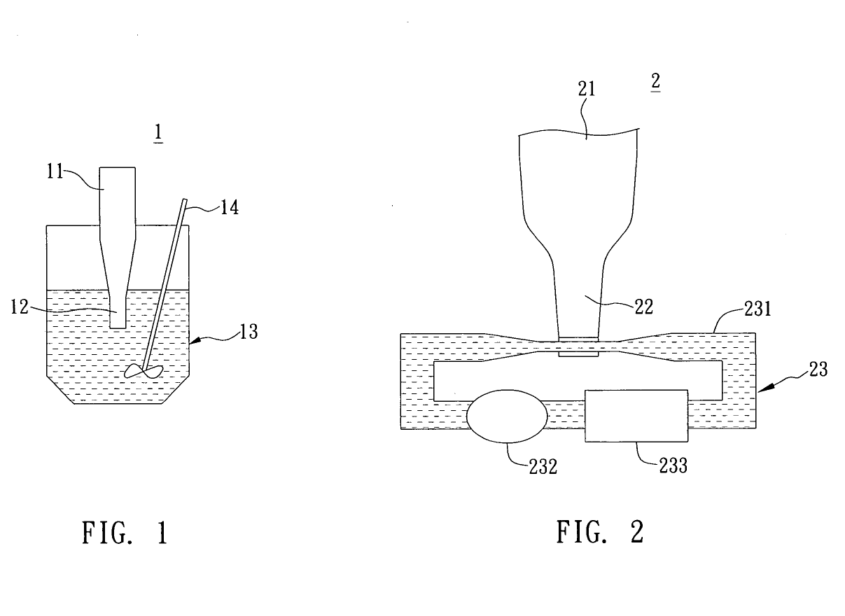

FIG. 2 is a structural schematic diagram of an ultrasonic disintegrator disclosed by Taiwanese Patent Application No. 093119250;

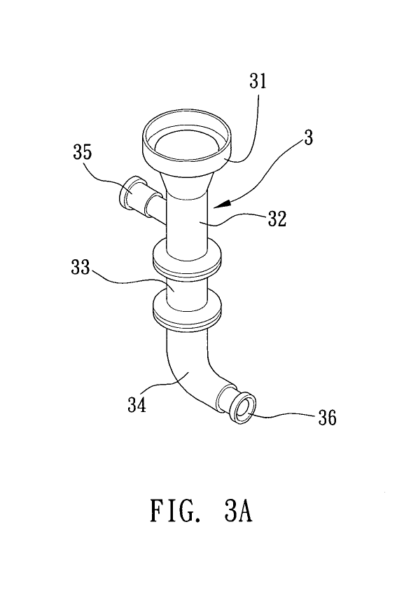

FIG. 3A is a 3D structural schematic diagram of a connector according to an embodiment of the present invention;

FIG. 3B is a side cross-sectional view of the connector shown in FIG. 3A;

FIGS. 4A and 4B are structural schematic diagrams of a high frequency vibration device having a connector according to the present invention; and

FIG. 5 is a schematic diagram of an actual application of a high frequency vibration device according to an embodiment of the present invention.

### DETAILED DESCRIPTION OF PREFERRED EMBODIMENTS

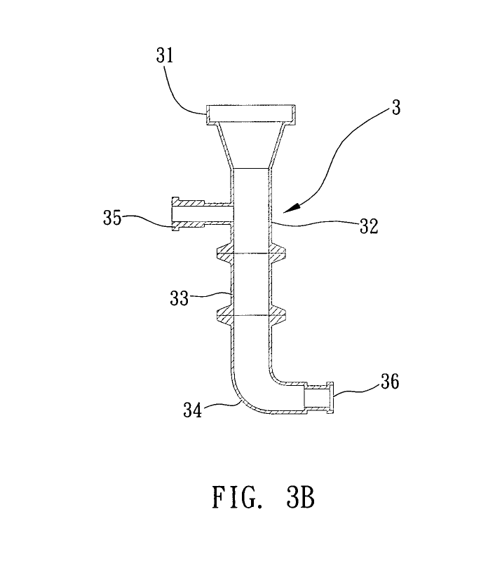

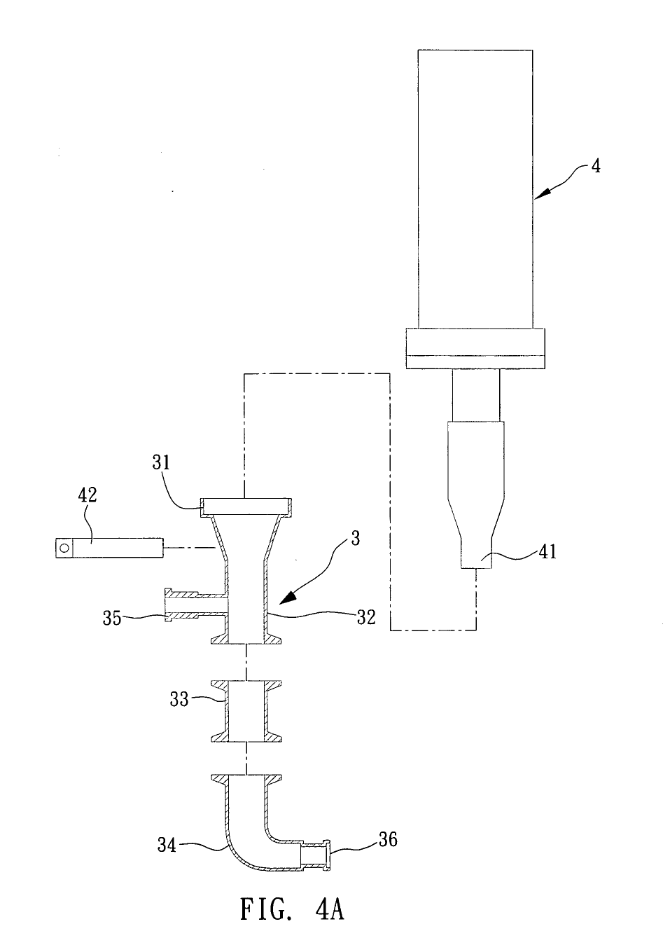

Preferred embodiments of a connector and a high frequency vibration device having the same as proposed by the present invention are described in detail as follows with reference to FIGS. 3A, 3B, 4 and 5. It should be understood that the drawings are simplified schematic diagrams only showing the components relevant to the present invention, and the layout of components can be more complicated and the number of the components can be adjusted in practical implementation.

The present invention is applicable to a high frequency disintegrator. The high frequency vibration generator can output high frequency vibration energy to the connector, thereby allowing a material to be disintegrated using the energy generated by the high frequency vibration generator, so as to extract contents (lysate) of the material.

FIGS. 3A and 3B are schematic diagrams of a connector according to an embodiment of the present invention. As shown in FIGS. 3A and 3B, the connector 3 of this embodiment can be shaped as a long tube made of a high-strength material such as stainless steel, titanium alloy, high nickel alloy, etc. In this embodiment, the connector 3 includes a connecting portion 31 for being connected to the high frequency vibration generator (to be described later), an action portion 32 axially extended from an end of the connecting portion 31, an extension portion 33 connected to the action portion 32, a bending portion 34 connected to the extension portion 33, and an inlet 35 and an outlet 36, which communicate with the action portion 32 and are located at different axial planes.

The action portion 32 may have an axially extended action channel, so as to increase the path and time through which the material introduced into the action portion 32 passess. The extension portion 33 is axially extended from the action portion 32 in a direction opposite to the connecting portion 31, so as to further increase the path and the time through which the material passes. As the action portion of this embodiment is connected to the extension portion 33, the inlet 35 and the outlet 36 communicate with the action portion 32 via the extension portion 33. Alternatively, in an embodiment without the extension portion 33, the action portion 32 can be directly connected to the inlet 35 and the outlet 36.

The bending portion 34 is connected to an end of the extension portion 33, and the connecting portion 31 is located at a top end of the action portion 32. The inlet 35 is provided on a side of the action portion 32 and communicates with the action portion 32, for allowing the material and a medium to be introduced into the action portion 32 (to be described later). The outlet 36 can be located at an end of the bending portion 34, such that the inlet 35 and the outlet 36 are located on different axial planes. Moreover, an inner diameter of the inlet 35 is smaller than that of the action portion 32, and thus excessive material can be avoided from entering the action portion 32 at a time, thereby preventing excessive material from accumulating in the action portion 32.

It should be noted that, for the sake of easy fabrication, the connector 3 may be assembled and fabricated in several stages in this embodiment. For example, the connecting portion 31, the action portion 32 and the inlet 35 are integrally formed, and the bending portion 34 and the outlet 36 are integrally formed, while the extension portion 33 is separately fabricated. It is also understood that, all or some of the aforementioned components of the connector 3 can be integrally formed. The extension portion 33 can be omitted and the action portion 32 is directly extended. Alternatively, the extension portion 33 and the bending portion 34 can be omitted and the action portion 32 is directly extended and partially bent. These are merely some illustrative examples of the present invention, while the present invention is not limited to these examples. As these examples can be well understood and implemented by persons skilled in the art, they are not shown in the drawings.

In other words, the present invention may also adopt any equivalent structure in which a the action portion 32 has an axially extended action channel, and the inlet 35 and the outlet 36, which communicate with the action portion 32, are respectively located on different axial planes.

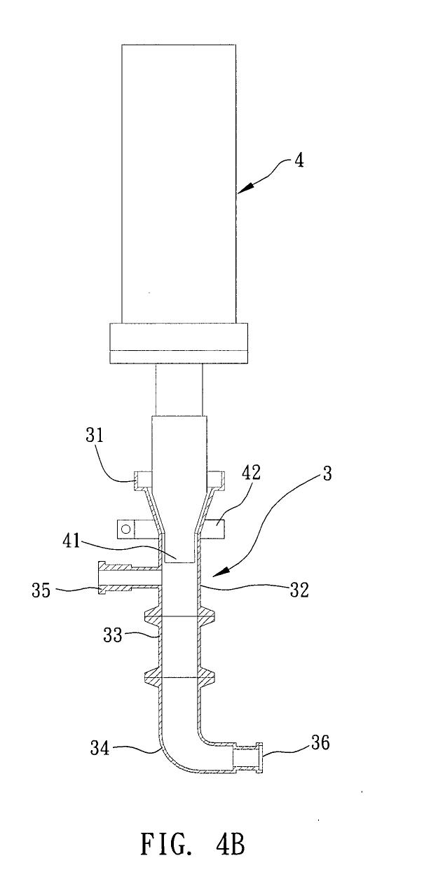

FIGS. 4A and 4B are schematic diagrams of a high frequency vibration device having a connector according to the present invention. As shown in FIGS. 4A and 4B, the high frequency vibration device includes the connector 3 and a high frequency vibration generator 4 installed on the connector 3. In this embodiment, the high frequency vibration generator 4 can be an ultrasonic vibration generator or any other equivalent component that may generate high frequency vibrations. The high frequency vibration generator 4 has an axially installed operational portion 41 that may axially output high frequency vibration energy (such as focused ultrasound). The operational portion 41 may comprise a piezoelectric material or any other equivalent material. In this embodiment, the connecting portion 31 can be a metallic pipe or sleeve provided around and attached to the operational portion 41, allowing a front part of the operational portion 41 to enter the action portion 32. A clamping portion 42 is used to fasten the connecting portion 31 and the operational portion 41. The clamping portion 42, such as a C-shaped ring, may be fixed the operational portion 41 peripherally by fasteners such as screws (not shown).

It is to be noted that, the connecting portion 31 is installed around the operational portion 41 and is fixed to the operational portion 41 by the clamping portion 42 in this embodiment, while in other embodiments, if the connecting portion 31 has been tightly fixed to or engaged with the operational portion 41, the clamping portion 42 and the corresponding fasteners may be omitted. Moreover, the connecting portion 31 is not limited to a pipe or sleeve, any other equivalent structure that connects the connector 3 to the high frequency vibration generator 4 is suitable for the present invention.

When in actual use, the inlet 35 of the connector 3 is externally connected to a machine containing a medium and a material (not shown). In this embodiment, the medium is, but not limited to, a liquid such as pure water. In other embodiments, the medium can be a gas or any other fluid. The material can be any material to be disintegrated, such as tea, ganoderma, mushroom, fruit, pearl or any material that requires disintegration, in order to extract the contents (or lysate) of the material. The medium is used to transmit or deliver the material and allow the material to enter the action portion 32 via the inlet 35. The operational portion 41 axially outputs high frequency vibration energy to generate a strong impact for disintegrating the material. The disintegrated materials are then transmitted to a next workstation via the outlet 36, and such workstation can be the inlet of a next connector or a heat exchanging device where a different task may be performed.

As the action portion 32 is able to axially extend the action length and range of the operational portion 41, thereby providing a longer path for the high frequency vibration energy to disintegrate the material. Further in this embodiment, the action portion 32 is axially connected to the extension portion 33, such that the material may be continuously subjected to the high frequency vibration energy in the single connector 3. Hence, the present invention increases the path and the time that the operational portion 41 impacts on the material so as to sufficiently disintegrate the material, thereby enhancing the evenness of powder particles after disintegration of the material, and allowing the contents (or lysate) of the material to be completely released.

Furthermore, as the extension portion 33 is axially extended from the end of the action portion 31, thereby allowing the action portion 32 to have a longer length due to the provision of the extension portion 33, such that the action time applied to the material in the connector 3 is increased, and thus the operational portion 41 may more evenly disintegrate the material. Hence, the material can be sufficiently disintegrated to completely release the contents (or lysate) thereof, thereby achieving the effect of even material disintegration as desired.

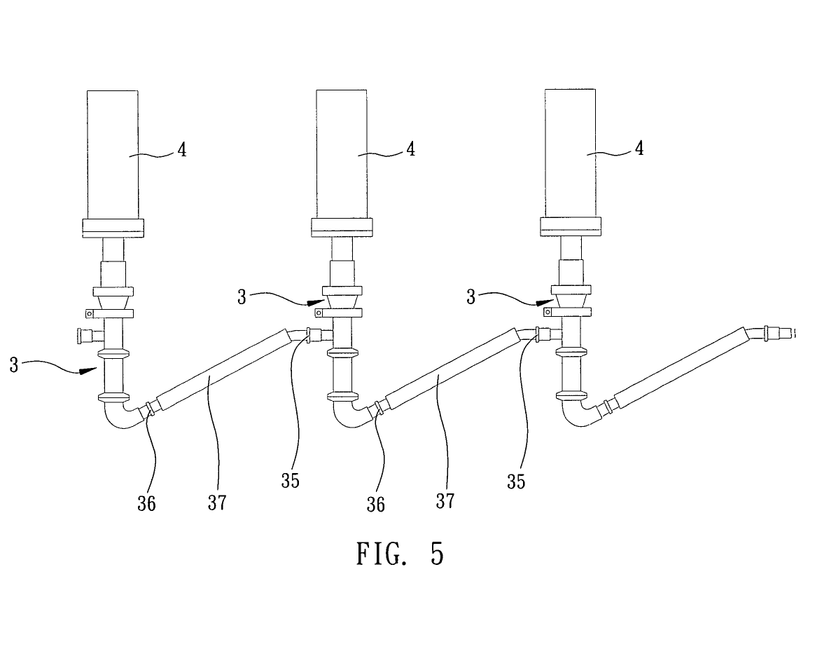

FIG. 5 is a schematic diagram of an actual application of a high frequency vibration device according to an embodiment of the present invention. As shown in FIG. 5, a plurality of transmission tubes 37 can be used to connect a plurality of connectors 3 in series. For example, the inlet 36 of one of the connectors 3 (i.e. the leftmost connector 3 in FIG. 5) is connected to one end of a transmission tube 37, and another end of the transmission tube 37 is connected to the inlet 35 of another connector 3 (i.e. the middle connector 3 in FIG. 5), and so forth. In this way, the high frequency vibration device may be constructed by multiple sets of the connectors 3 and the high frequency vibration generators 4 that are connected in series, and is suitable for large-scale use.

This embodiment only illustrates an example of the high frequency vibration device comprising three sets of the connectors 3 and the high frequency vibration generators 4 connected in series as shown in FIG. 5; however, persons skilled in the art certainly understand that the number and manner of the serially connected components are not limited to such example. For instance, two or more sets of the connectors 3 and the high frequency vibration generators 4 can be connected in series. Alternatively, the transmission tubes 37 (such as soft tubes) can be omitted, while the outlet 36 of a connector 3 is allowed to be directly connected to the inlet 35 of another connector 3. The length of the outlet 36 and/or inlet 35 can be extended. Corresponding threaded structures (such as screws and screw holes) can be provided respectively on the outlet 36 and the inlet 35 so as to fix and engage the outlet 36 and the inlet 35 to and with each other. And, seal rings can be disposed between the outlet 36 and the inlet 35 to maintain a sealed state.

In addition, although the adjacent connectors 3 are connected in series in this embodiment, not all the connectors 3 are connected in series, for example, the first connector 3 is not directly connected to the last connector 3. Alternatively, in other embodiments, the first connector 3 can be directly connected in series to the last connector 3 so as to continuously circulate and disintegrate the material.

Therefore, many alternatives, modifications and variations would be apparent to and implemented by persons skilled in the art, such that they are not shown in the drawings and are not further detailed here.

In comparison to the conventional techniques, the connector of the present invention provides a longer action time and path to simultaneously disintegrate a more amount of the material evenly, thereby applicable for large-scale use. Accordingly, the uneven disintegration problem due to radial operation and short action distance of the conventional techniques has been solved. Also, the connector of the present invention is also suitable for series-connection configuration, and thus is able to correct the defect of the conventional techniques not suitable for large-scale use due to failure in series-connection configuration. Therefore, the connector and the high frequency vibration device having the same according to the present invention have overcome the defects of uneven disintegration and not suitable for large-scale use in the conventional techniques, such that the present invention has high industrial applicability.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A connector applicable to a high frequency vibration generator of a high frequency disintegrator, for allowing the high frequency vibration generator to output high frequency vibration energy, the connector comprising:
a connecting portion connected to the high frequency vibration generator;
an action portion axially extended from an end of the connecting portion, for allowing the high frequency vibration generator to output the high frequency vibration energy axially; and
an inlet and an outlet, which communicate with the action portion and are located on different axial planes respectively.

2. The connector of claim 1, further comprising an extension portion integrally extended from an end of the action portion opposite to the connecting portion.

3. The connector of claim 2, further comprising a bending portion connected to the extension portion, wherein the outlet is located at an end of the bending portion.

4. The connector of claim 1, wherein the action portion comprises an action channel.

5. The connector of claim 1, wherein the inlet allows a material and a medium to be introduced into the action portion.

6. The connector of claim 1, wherein an inner diameter of the inlet is smaller than that of the action portion.

7. A high frequency vibration device, comprising:
a high frequency vibration generator having an axially installed operational portion for outputting high frequency vibration energy; and
a connector comprising a connecting portion axially connected to the operational portion; an action portion axially extended from an end of the connecting portion, for allowing the high frequency vibration generator to output the high frequency vibration energy axially; and an inlet and an outlet, which communicate with the action portion and are located on different axial planes respectively.

8. The high frequency vibration device of claim 7, wherein the connector further comprises an extension portion integrally extended from an end of the action portion opposite to the connecting portion.

9. The high frequency vibration device of claim 8, wherein the connector further comprises a bending portion connected to the extension portion, wherein the outlet is located at an end of the bending portion.

10. The high frequency vibration device of claim 7, wherein the action portion comprises an action channel.

11. The high frequency vibration device of claim 7, wherein the connector further comprises a clamping portion connecting the connecting portion to the high frequency vibration generator.

12. The high frequency vibration device of claim 7, wherein the inlet allows a material and a medium to be introduced into the action portion.

13. The high frequency vibration device of claim 7, wherein an inner diameter of the inlet is smaller than that of the action portion.

14. A high frequency vibration device, comprising:
a plurality of high frequency vibration generators each having an axially installed operational portion for outputting high frequency vibration energy; and
a plurality of connectors each comprising a connecting portion axially connected to the operational portion of a corresponding one of the high frequency vibration generators; an action portion axially extended from an end of the connecting portion, for allowing the corresponding one of the high frequency vibration generators to output the high frequency vibration energy axially; and an inlet and an outlet, which communicate with the action portion and are located on different axial planes respectively, wherein the connectors are connected in series.

15. The high frequency vibration device of claim 14, wherein each of the connectors further comprises an extension portion integrally extended from an end of the action portion opposite to the connecting portion.

16. The high frequency vibration device of claim 15, wherein each of the connectors further comprises a bending portion connected to the extension portion, wherein the outlet is located at an end of the bending portion.

17. The high frequency vibration device of claim 14, wherein each of the connectors further comprises a clamping portion connecting the connecting portion to the corresponding one of the high frequency vibration generators.

18. The high frequency vibration device of claim 14, wherein the inlet allows a material and a medium to be introduced into the action portion.

19. The high frequency vibration device of claim 14, wherein an inner diameter of the inlet is smaller than that of the action portion.

20. The high frequency vibration device of claim 14, further comprising at least a transmission tube installed between the outlet of one of the connectors and the inlet of an adjacent one of the connectors.
